(19) United States
(12) Patent Application Publication
(10) Pub. No.: US 2002/0036694 A1
(43) Pub. Date: Mar. 28, 2002

(54) Method and system for the storage and retrieval of web-based educational materials

(76) Inventor: Jonathan R. Merril, Great Falls, VA (US)

Correspondence Address: BURNS DOANE SWECKER & MATHIS L L P, POST OFFICE BOX 1404, ALEXANDRIA, VA, 22313-1404, US

(21) Appl. No.: 09/955,939

(22) Filed: Sep. 20, 2001

Related U.S. Application Data
(63) Continuation-in-part of application No. 09/073,871, filed on May 7, 1998.

(51) Int. Cl. H04N 5/225; G02B 13/16; H04N 5/222

(52) U.S. Cl. 348/220; 348/373; 348/333.01; 348/552; 348/335; 386/96; 386/117

(57) ABSTRACT

A system is provided that automatically digitally captures lecture presentation slides and speech and stores the data in a memory. This system also prepares this information for Internet publication and publishes it on the Internet for distribution to end-users. The system generally comprises three main functions (1) capturing the lecture and storing it into a computer memory or database, (2) generating a transcript from the lecture and the presentation slides and automatically summarizing and outlining the transcripts, and (3) publishing the lecture slides image data, audio data, and transcripts on the Internet for use by client computers. The system synchronizes the slide image data, audio data and the transcripts, and the clients can view and search the published lecture data. A mirror assembly is also provided that changes the angle of the light projected during a presentation from a slide image projector to a digital camera for digital image data capture.

Priority is claimed to U.S. application Ser. No. 09/073,871, filed May 7, 1998, herein incorporated by reference.

### BACKGROUND

1. Field of the Invention

The present invention generally relates to a data processing system for digitally recording lectures and presentations. More particularly, it relates to the conversion of these lectures with little intervention to a standard Internet format for publication.

2. Related Art

The majority of corporate and educational institution training occurs in the traditional lecture format in which a speaker addresses an audience to disseminate information. Due to difficulties in scheduling and geographic diversity of speakers and intended audiences, a variety of techniques for recording the content of these lectures have been developed. These techniques include videotapes, audio tapes, transcription to written formats and other means of converting lectures to analog (non-computer based) formats.

More recently, with the advent and growing acceptance of the Internet and the World Wide Web, institutions have started to use this communication medium to broadcast lectures. Conventionally, in order to create a Web-based lecture presentation that utilizes 35-mm slides or other projected media and that includes audio, a laborious process is necessary. This process involves manually removing each slide and digitizing it and manually recording and digitizing the audio into a Web-based format. In addition, to complete the lecture materials, each slide must be manually synchronized with the respective portion of audio. Thus, the entire process of converting lecture into a format that can be published on the Internet is labor intensive, time-consuming and expensive.

One technological challenge has been allowing audio/visual media to be made available on relatively low bandwidth connections (such as 14.4 kilobits/second modems). Native audio and visual digital files are too large to receive in a timely manner over these low bandwidth modems. This technological challenge becomes prohibitive when one attempts to transmit a lecture over the Internet, which requires slide updates while maintaining simultaneous audio transmission. To this end, Real Networks™ , Microsoft™, VDOlive™ and several other companies have commercialized a variety of techniques which allow for continuous, uninterrupted transmission of sound and images over the Internet, even over low bandwidth connections. This format, known as “streaming”, does not require the end-user to obtain the entire audio or video file before they can see or hear it. Recently, Microsoft has provided a standard media format for Web-based multimedia transmission over the Internet. This standard is called the “Active Streaming Format” (ASF). The ASF Format is further described at the Internet website http://www.Microsoft.com/mind/0997/netshow/netshow.htm, which is incorporated herein by reference.

Furthermore, a variety of manufacturers (e.g., Kodak, Nikon, AGFA) have developed technologies for scanning 35 mm slides and digitizing them. However, these systems have several disadvantages. Most significantly, they require removal of the slides from a slide carousel. Additionally, they require a separate, time-consuming, scanning process (on the order of several seconds per slide), and as a result, a lecturer cannot use the scanners when giving a presentation due to the delay of scanning each slide independently. Furthermore, they are not optimized for capturing slide information for the resolution requirements of the Internet. These requirements are generally low compared with typical slide scanners, since smaller file size images are desired for Internet publishing. Finally, they are not designed to capture audio or presentation commands (such as forward and reverse commands for slide changes).

One device introduced to the market under the name “CoolPix 30O™” (available from Nikon of Melville, N.Y.) allows for digital video image and digital audio capture as well as annotation with a stylus. However, the device does not permit slide scanning and does not optimize the images and audio for use on the Internet. Its audio recording is also limited to a relatively short 17 minutes. Similarly, digital audio/video cameras (such as the Sony Digital Handycam series) allow for the digital video and audio recording of lectures but have no direct means of capturing slides. In addition, they are not set up to record information in a manner that is optimized for the Internet. Generally, with these systems, the amount of audio captured is limited to about one hour before a new cassette is required to be inserted into the camera.

Although these conventional techniques offer the capability to transmit educational materials, their successful deployment entails significant additional manual efforts to digitize, synchronize, store, and convert to the appropriate digital format to enable use on the Internet. Adding to the cost and delay, additional technical staff may be required to accomplish these goals. Further, there is a time delay between the lecture and its availability on the Internet due to the requirement that the above processes take place. As such, the overall time required for processing a lecture using, conventional methods and systems is five to ten hours.

Another related technology for storing, searching and retrieving video information is called the “Infomedia Digital Video Library” and was developed by Carnegie Mellon University of Pittsburgh, Pa. However, the system under consideration will use previously recorded materials for inclusion into the database and thus makes no provisions for recording new materials and quickly transferring them into the database. Moreover, in this effort, there was no emphasis on slide-based media.

It is therefore desirable to provide a system that allows a presenter to store the contents of a lecture so that it may be broadcast across the Web. It is further desirable to provide a system that allows the efficient searching and retrieval of these Web-based educational materials.

### SUMMARY

Methods and systems consistent with the present invention satisfy this and other desires by optimizing and automating the process of converting lecture presentations into a Web-based format and allowing for the remote searching and retrieval of the information. Typically, systems consistent with the present invention combine the functionality of a projection device, a video imaging element, an audio recorder, and a computer. Generally, the computer implements a method for the conversation and enhancement of the captured lectures into a Web-based format that is fully searchable, and the lecture can be served immediately to the Internet.

A method is provided for recording and storing a lecture presentation using slides and audio comprising the steps of initiating display of a slide image, capturing slide image data from the slide image automatically in response to the initiation and storing the slide image data in the memory. The method may further include the steps of recording audio signals associated with the slide image, capturing audio data from the audio signals, and storing the audio data in a memory.

The advantages accruing to the present invention are numerous. For example, a presenter of information can capture his or her information and transform it into Web-based presentation with minimal additional effort. This Web-based presentation can then be served to the Internet with little additional intervention. The nearly simultaneous recording, storage and indexing of educational content using electronic means reduces processing time from more than five hours to a matter of minutes. Systems consistent with the present invention also provide a means of remotely searching and retrieving the recorded educational materials.

In one implementation, optical character recognition and voice recognition software can be run on the slide data and audio recordings to produce transcripts. Using additional software, these transcripts can be automatically indexed and summarized for efficient searching.

A method is also provided for recording and storing a lecture presentation that uses computer generated images and audio comprising the steps of creating from an analog video signal a first digital and second signals, displaying the image from the second signal, and recording the audio portion of a speaker's presentation during a live presentation and automatically synchronizing changeover from one image for display to another with the audio recording. This method may further include the steps of storing the images from the first signals in a database and providing search capabilities for searching the database.

Embodiments are also shown for use in capturing a live presentation for display over a network, where the images for display are computer generated, the embodiments comprise a display device for projecting the images, an image signal splitting device for creating a first and second image signal, a personal computer for supplying computer generated image signals, a recording device for recording an audio portion of a live presentation, a processor for synchronizing the recorded portion of the live presentation with the first image signals, a processor for converting the audio recordings of the first image signals into at least one format for presentation to a client over a network and a connecting device for supplying the audio recordings and the image signals in at least format to a network to be accessed by clients. The embodiments range in varying degrees of integration of these components, from total integration in the form of a projector to modularization wherein the components and functions are separated into a video projector, an intermediate unit, a personal computer and a server.

The above desires, other desires, features, and advantages of the present invention will be readily appreciated by one of ordinary skill in the art from the following detailed description of the preferred implementations when taken in connection with the accompanying drawings.

### BRIEF DESCRIPTION OF THE DRAWINGS

FIG. 1 illustrates hardware components of a system consistent with present invention;

FIG. 2 illustrates a mirror assembly used to redirect light from a projection device to a digital camera consistent with the present invention;

FIG. 3 depicts the components of a computer consistent with the present invention;

FIG. 4 illustrates alternate connections to an overhead projector and LCD projector consistent with the present invention;

FIG. 5 shows input and output jacks on a system consistent with the present invention;

FIG. 6 is a flowchart illustrating a method for capturing a lecture consistent with the present invention;

FIG. 7 is a flowchart illustrating a method for enhancing, a captured lecture consistent with the present invention;

FIG. 8 is a flowchart illustrating a method for publishing a captured lecture on the Internet consistent with the present invention;

FIG. 9 shows an example of a front-end interface used to access the database information consistent with the present invention;

FIG. 10 shows a schematic of a three-tier architecture consistent with the present invention;

FIG. 11 shows an alternative implementation consistent with the present invention in which the projection device is separate from the lecture capture hardware;

FIG. 12 shows alternate connections to an overhead projector with a mirror assembly consistent with the present invention;

FIG. 13 depicts the components of a embodiment for capturing a live presentation where the images are computer generated;

FIG. 14 is a flow chart illustrating a method for capturing a lecture consistent with an illustrated embodiment;

FIG. 15 depicts the components of another embodiment for use in capturing a live presentation in which the images are computer generated;

FIG. 16 is a flow chart illustrating a method for capturing a live presentation consistent with an illustrated embodiment;

FIG. 17 depicts the components of another embodiment for capturing live presentations where the images are computer generated;

FIG. 18 is a flow chart illustrating a method for capturing a live presentation consistent with an illustrated embodiment;

FIG. 19 depicts the components of another embodiment for capturing a live presentation where the images are computer generated; and

FIG. 20 is a flow chart illustrating a method for capturing a live presentation consistent with an illustrated embodiment.

### DETAILED DESCRIPTION

Systems consistent with the present invention digitally capture lecture presentation slides and speech and store the data in a memory. They also prepare this information for Internet publication and publish it on the Internet for distribution to end-users. These systems comprise three main functions: (1) capturing the lecture and storing it into a computer memory or database, (2) generating, a transcript from the lecture and the presentation slides and automatically summarizing and outlining the transcripts, and (3) publishing the lecture slides image data, audio data, and transcripts on the Internet for use by client computers.

Generally, when the lecturer begins presenting, and the first slide is displayed on the projection screen by a projector, a mirror assembly changes the angle of the light being projected on the screen for a brief period of time to divert it to a digital camera. At this point, the digital camera captures the slide image, transfers the digital video image data to the computer, and the digital video image data is stored on the computer. The mirror assembly then quickly flips back into its original position to allow the light to be projected on the projection screen as the lecturer speaks. When this occurs, an internal timer on the computer begins counting. This timer marks the times of the slide changes during the lecture presentation. Simultaneously, the system begins recording the sound of the presentation when the first slide is presented. The digital images of the slides and the digital audio recordings are stored on the computer along with the time stamp information created by the timer on the computer to synchronize the slides and audio.

Upon each subsequent slide change, the mirror assembly quickly diverts the projected light to the digital camera to capture the slide image in a digital form, and then it flips back into its original position to allow the slide to be displayed on the projection screen. The time of the slide changes, marked by the timer on the computer, is recorded in a file on the computer. At the end of the presentation, the audio recording stops, and the computer memory stores digital images of each slide during the presentation and a digital audio file of the lecture speech. Additionally, it will have a file denoting the time of each slide change.

Alternatively, in another implementation, slides can be generated using machines that are not conventional slide projectors. A computer generated slide presentation can be used, thereby avoiding the need of the mirror assembly and the digital camera. In the case of the computer generated slide (PowerPoint® available from Microsoft Corporation of Redmond, Wash.) or other data from any application software which a presenter is using for a presentation on his or her computer. The digital video image data from the computer generating the slide is transferred to the system's computer at the same time that the slide is projected onto the projection screen. Similarly, slides may be projected from a machine using overhead transparencies or paper documents. This implementation also avoids the need for the mirror assembly and the digital camera, because it, like the computer generated presentations, transfer the image data directly to the computer for storage at the same time that it projects the image onto the projection screen. Any of these methods or other methods may be used to capture digital video image data of the presentation slides in the computer. Once stored in the computer, the digital video and audio files may be published to the Internet or, optionally, enhanced for more efficient searching on the Internet.

During the optional lecture enhancement, optical character recognition software is applied to each slide image to obtain a text transcript of the words on a slide image. Additionally, voice recognition software is applied to the digital audio file to obtain a transcript of the lecture speech. To enhance the recognition accuracy, each speaker may read a standardized text passage (either in a linear or interactive fashion in which the system re-prompts the end-user to re-state passages which are not recognized in order to enhance its recognition accuracy) into the system prior to presenting and in doing so; allow the speech recognition system additional data with which recognition accuracy will be increased. Speech recognition systems which provide for interactive training and make use of standardized passages (which the end-user reads to the system) to increase accuracy are available from a variety of companies including Microsoft, IBM and others. Once these transcripts are obtained, automatic summarization and outlining software can be applied to the transcripts to create indexes and outlines easily searchable by a user. In addition to the enhanced files, the user will also be able to search the whole transcript of the lecture speech.

Alternatively, if Closed Captioning is used during a presentation, the close caption data can be parsed from the input to the device and a time-stamp can be associated with the captions. Parsing of the Closed Caption data can occur either through the use of hardware (with a Closed Caption decoder chip (such as offered by Philips Electronics (see, semiconductors.philips.com/acrobat/various/MPC.pdf on the world wide web) or Software (such as offered by Ccaption (see, ccaption.com on the world wide web)). The close caption data can be used to provide indexing information for use in search and retrieval for all or parts of individual or groups of lectures.

In addition, information and data, which are used during the course of presentation(s), can be stored in the system to allow for additional search and retrieval capabilities. The data contained and associated with files used in a presentation can be stored and this data can be used in part or in whole to provide supplemental information for search and retrieval. Presentation materials often contain multiple media types including text, graphics, video, and animations. With extraction of these materials, they can be placed in the database to allow additional search and retrieval access to the content. Alternatively, the data can be automatically indexed using products, which provide this functionality such as Microsoft Index Server or Microsoft Portal Server.

Finally, after transferring the files to a database, systems consistent with the present invention publish these slide image files, audio files and transcript files to the Internet for use by Internet clients. These files are presented so that an Internet user can efficiently search and view the lecture presentation.

Systems consistent with the present invention thus allow a lecture presentation to be recorded and efficiently transferred to the Internet as an active or real time streaming for use by end-users. The present invention is therefore not only efficient at publishing lectures on the Web, but is an efficient mechanism for recording the content of meetings, whether business, medical, judicial or another type of meeting. At the end of a meeting, for instance, a record of the meeting complete with recorded slides, audio and perhaps video can be stored. The stored contents can be placed on a removable media such as a re-writable compact disc (CD-R), re-writable digital versatile disc (DVD-R) or any type of recordable media to be carried away by one or more of the participants.

Further, the present invention can be used as an effective teleconferencing mechanism. Specifically, so long as a participate in a teleconference has a device in accordance with the present invention, his or her presentation can be transmitted to other participates using the recorded presentation which has been converted to a suitable Internet Protocol. The other participants can use similar devices to capture, enhance and transmit their presentations, or simply have an Internet enabled computer, Internet enabled television, wireless device with Internet access or like devices.

Whereas several implementations of the present invention are possible, some alternative embodiments are also discussed below.

### System Description

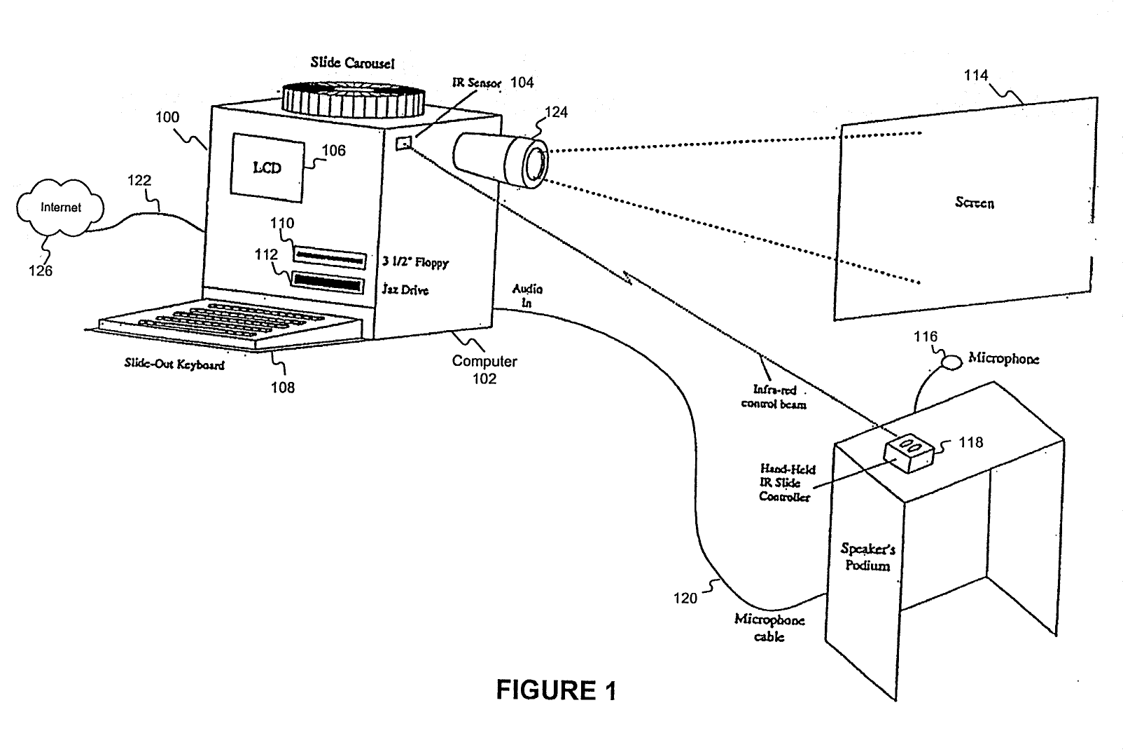

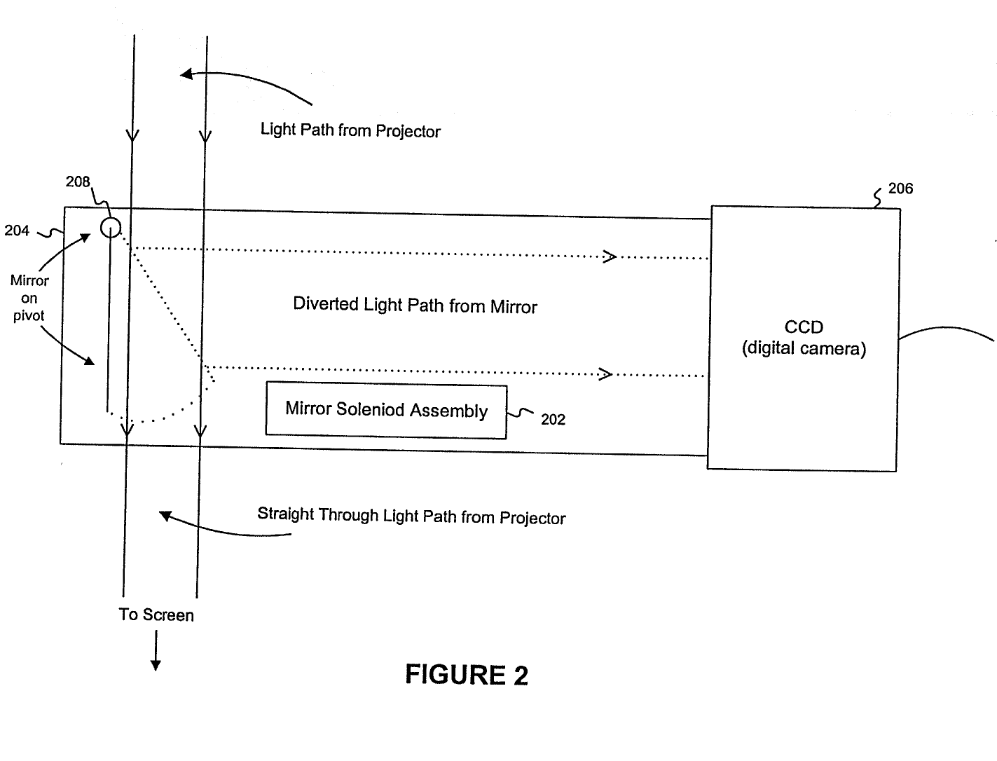

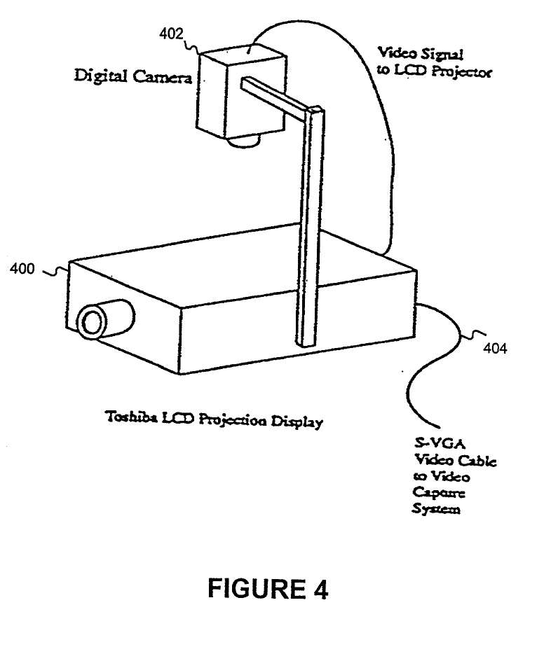

FIGS. 1 and 2 illustrate hardware components in a system consistent with the present invention. Although FIG. 1 shows an implementation with a slide projector, the system allows a presenter to use a variety of media for presentation: 35 mm slides, computer generated stored and/or displayed presentations, overhead transparencies or paper documents. The overhead transparencies and paper documents will be discussed below with reference to FIG. 4.

FIG. 1 demonstrates the use of the system with an integrated 35 mm slide projector 100 that contains a computer as a component or a separate unit. The output of the projection device passes through an optical assembly that contains a mirror, as shown in FIG. 2. In the implementation shown in FIG. 1, the mirror assembly 204 is contained in the integrated slide projector 100 behind the lens 124 and is not shown on the FIG. 1. This mirror assembly 204 diverts the light path to a charge-coupled device (CCD) 206 for a brief period of time so that the image may be captured. A CCD 206 is a solid-state device that converts varying, light intensities into discrete digital signals, and most digital cameras (e.g., the Pixera Professional Digital Camera available from Pixera Corporation of Los Gatos, Calif.) use a CCD for the digital image capturing process. The video signal carrying the digital video image data from the CCD 206, for example, enters a computer 102, which is integrated within the projection box in this implementation, via a digital video image capture board contained in the computer (e.g, TARGA 2000 RTX PCI video board available from Truevision of Santa Clara, Calif.). Naturally, the image signal can be video or a still image signal. This system is equipped with a device (e.g., Grand TeleView available from Grandtec UK Limited, Oxon, UK) that converts from SVGA or Macintosh computer output and allows for conversion of this signal into a format which can be captured by the Truevision card, whereas the Truevision card accepts an NTSC (National Television Standards Committee) signal.

As the lecturer changes slides or transparencies, the computer 102 automatically records the changes. Changes are detected either by an infrared (IR) slide controller 118 and IR sensor 104, a wired slide controller (not shown) or an algorithm driven scheme implemented in the computer 102 which deletes changes in the displayed image.

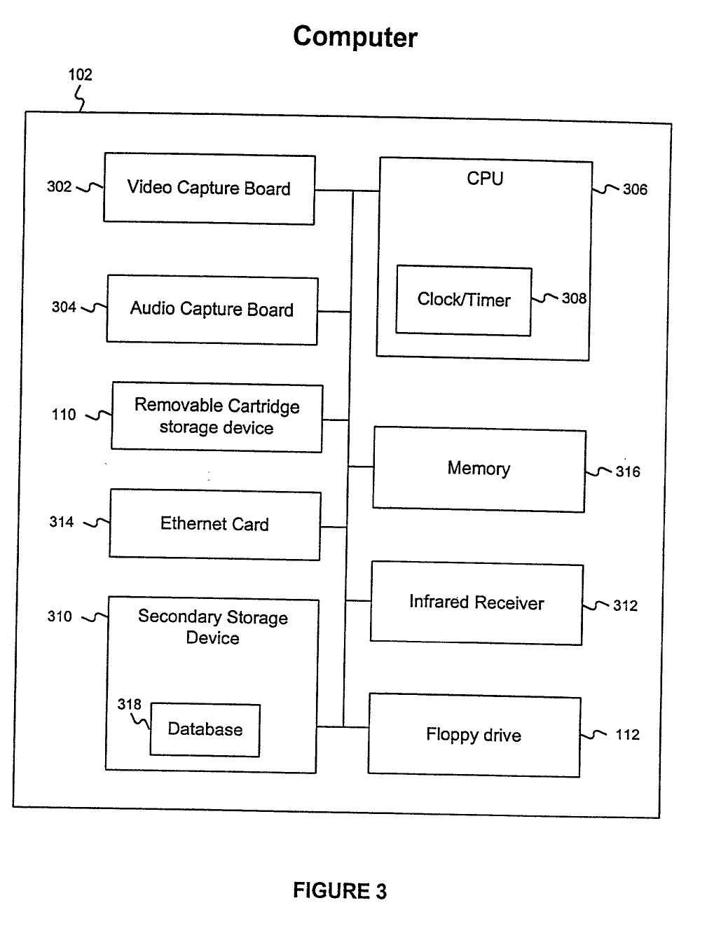

As shown in FIG. 2, when a slide change is detected either via the slide controller 118 or an automated algorithm, the mirror 208 of the mirror assembly 204 is moved into the path of the projection beam at a 45-degree angle. A solenoid 202, an electromagnetic device often used as a switch, controls the action of the mirror 208. This action directs all of the light away from the projection screen 114 and towards the CCD 206. The image is brought into focus on the CCD 206, digitally encoded and transmitted to the computer 102 via the video-capture board 302 (shown in FIG. 3 described below). At this point, the mirror 208 flips back to the original position allowing the light for the new slide to be directed towards the projection screen 114. This entire process takes less than one second, since the image capture is a rapid process. Further, this rapid process is not easily detectable by the audience since there is already a pause on the order of a second between conventional slide changes. In addition, the exact time of the slide chances, as marked by a timer in the computer, is recorded in a file on the computer 102.

FIG. 3 depicts the computer 102 contained in the integrated slide projector 100 in this implementation. It consists of a CPU 306 capable of running Java applications (such as the Intel Pentium (e.g., 400 MHz Pentium II Processors) central processors and Intel Motherboards (IntelB N440 BX server board) from Intel of Santa Clara, Calif.), an audio capture card 304 (e.g., AWE64 SoundBlaster™ available from Creative Labs of Milpitas, Calif.), a video capture card 302, an Ethernet card 314 for interaction with the Internet 126, a memory 316, and a secondary storage device 310. The secondary storage device 310 in a preferred embodiment can be a combination of solid state Random Access Memory (RAM) that buffers the data, which is then written onto a Compact Disc Writer (CD-R) or Digital Versatile Disc Writer (DVD-R). Alternatively a combination or singular use of a hard disk drive, or removable storage media and RAM can be used for storage. Using removable memory as the secondary storage device 310 enables users to walk away from a lecture or meeting with a complete record of the content of the lecture or meeting. The advantages are clear. Neither notes nor complicated, multi-format records will have to be assembled and stored. Achieving the actual contents of the lecture or meeting is made simple and contemporaneous. Participant(s) will simply leave the lecture or meeting with an individual copy of the lecture or meeting contents on a disc.

The computer 102 also includes or is connected to an infrared receiver 312 to receive a slide change signal from the slide change controller 118. The CPU 306 also has a timer 308 for marking slide change times, and the secondary storage device 310 contains a database 18 for storing and organizing the lecture data. The system will also allow for the use of alternative slide change data (which is provided as either an automated or end-user selectable feature) which obtains data any combination of data from: (1) a computer keyboard which can be plugged into the system (2) the software running on the presenters' presentation computer which can send data to the capture device (3) or an internally generated timing event within the device which triggers image capture. For example, image capture of the slide(s) can be timed to occur at predetermined or selectable periods. In this way, animation, video inserts, or other dynamic images in computer generated slide shows can be captured at least as stop action sequences. Alternatively or additionally, the slide capture can be switched to a video or animation capture during display of dynamically changing images such as occurs with animation or video inserts in computer generated slides. Thus, the presentation can be fully captured including capture of the dynamically changing images, but at the expense of greater file size.

Referring back to FIG. 1, the computer 102 contains an integrated LCD display panel 106, and a slide-out keyboard 108 used to switch among three modes of operation discussed below. For file storage and transfer to other computers, the computer 102 also contains a floppy drive 112 and a high-capacity removable media drive 110, such as a Jaz™ drive available from Iomega of Roy, Utah (iomega.com/jaz/ on the World Wide Web). The computer 102 may also be equipped with multiple CPUs 306, thus enabling the performance of several tasks simultaneously, such as capturing a lecture and serving a previous lecture over the Internet.

Simultaneously with the slide capturing, audio signals are recorded using a microphone 116 connected by a cable 120 to the audio capture card 304 which is an analog-to-digital converter in the computer 102, and the resulting audio files are placed into the computer's secondary storage device 310 in this exemplary embodiment.

In one implementation consistent with the present invention, the presentation slides are computer generated. In the case of a computer generated presentation, the image signal from the computer (not shown) generating the presentation slides is sent to a VGA to NTSC conversion device and then to the video capture board 302 before it is projected onto the projection screen 114, thus eliminating the need to divert the beam or use the mirror assembly 204 or the CCD 206. This also results in a higher-quality captured image.

FIG. 4 illustrates hardware for use in another implementation in which overhead transparencies or paper documents are used instead of slides or computer generated images. Shown in FIG. 4 is an LCD projector 400 with an integrated digital camera 402, such as the Toshiba MediaStar TLP-511 U. This projection device allows overhead transparencies and paper documents to be captured and converted to a computer image signal, such as SVGA. This SVGA signal can then be directed to an SVGA-input cable 404. In this case, the computer 102 detects the changing of slides via an algorithm that senses abrupt changes in image signal intensity, and the computer 102 records each slide change. As in the computer generated implementation, the signal is captured directly before being projected, (i.e., the mirror assembly 204 and CCD 206 combination shown in FIG. 2 is not necessary).

In one implementation, optical character recognition is performed on the captured slide data using a product such as EasyReader Elite™ from Mimetics of Cedex, France. Also, voice recognition is performed on the lecture audio using a product such as Naturally Speaking™ available from Dragon Systems of Newton, Mass. These two steps generate text documents containing full transcripts of both the slide content and the audio of the actual lecture. In another implementation, these transcripts are passed through outline-generating software, such as LinguistX™ from InXight of Palo Alto, Calif., which summarizes the lecture transcripts, improves content searches and provides indexing. Other documents can then be linked to the lecture (i.e., an abstract, author name, date, time, and location) based on the content determination. The information contained in the materials (or the native files themselves) used during the presentation can also be stored into the database to enhance search and retrieval through any combination or singular use of the following: (1) use of this data in a native format which is stored within a database, (2) components of the information stored in the database, (3) pointers to the data which are stored in the database.

Most of these documents (except, e.g., those stored in their native format), along with the slide image information, are converted to Web-ready formats. This audio, slide, and synchronization data is stored in the database 318 (e.g. Microsoft SQL) which is linked to each of the media elements. The linkage of the database 318 and other media elements can be accomplished with an object-linking model, such as Microsoft's Component Object Model (COM). The information stored in the database 318 is made available to Internet end-users through the use of a product such as Microsoft Internet Information Server (IIS) software, and is fully searchable.

Methods and systems consistent with the present invention thus enable the presenter to give a presentation and have the content of the lecture made available on the Internet with little intervention. While performing the audio and video capture, the computer 102 automatically detects slide changes (i.e., via the infrared slide device or an automatic sensing algorithm), and the slide changes information is encoded with the audio and video data. In addition, the Web-based lecture contains data not available at the time of the presentation such as transcripts of both the slides and the narration, and an outline of the entire presentation. The presentation is organized using both time coding and the database 18, and can be searched and viewed using a standard Java™ enabled Web-interface, such as Netscape Navigator™. Java is a platform-independent, object-oriented language created by Sun Microsystems™. The Java programming language is further described in “The Java Language Specification” by James Gosling, Bill Joy, and Guy Steele, Addison-Wesley, 1996, which is herein incorporated by reference. In one implementation, the computer 102 serves the lecture information directly to the Internet if a network connection 122 is established using the Ethernet card 314 or modem (not shown). Custom software, written in Java for example, integrates all of the needed functions for the computer.

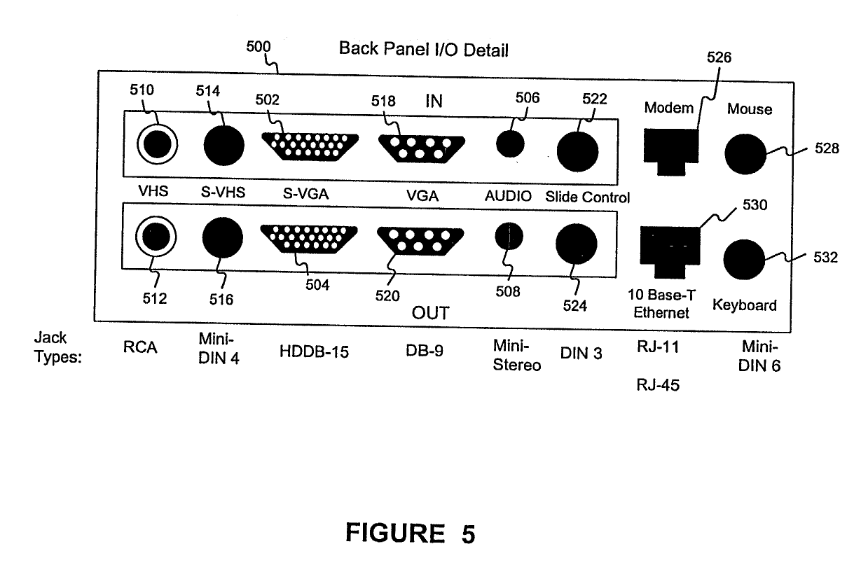

FIG. 5 shows, in detail, the ports contained on the back panel 500 of the integrated 35-mm slide projection unit 100 consistent with the present invention: SVGA-in 502, SVGA-out 502, VHS and SVHS in and out 510-516, Ethernet 530, modem 526, wired slide control in 522 and out 524, audio in 506 and out 508, keyboard 532 and mouse port 528. In addition, a power connection (not shown) is present.

### Operation

Generally, three modes of operation will be discussed consistent with the present Invention. These modes include: (1) lecture-capture mode, (2) lecture enhancement mode, and (3) Web-publishing mode.

1) Capturing Lectures

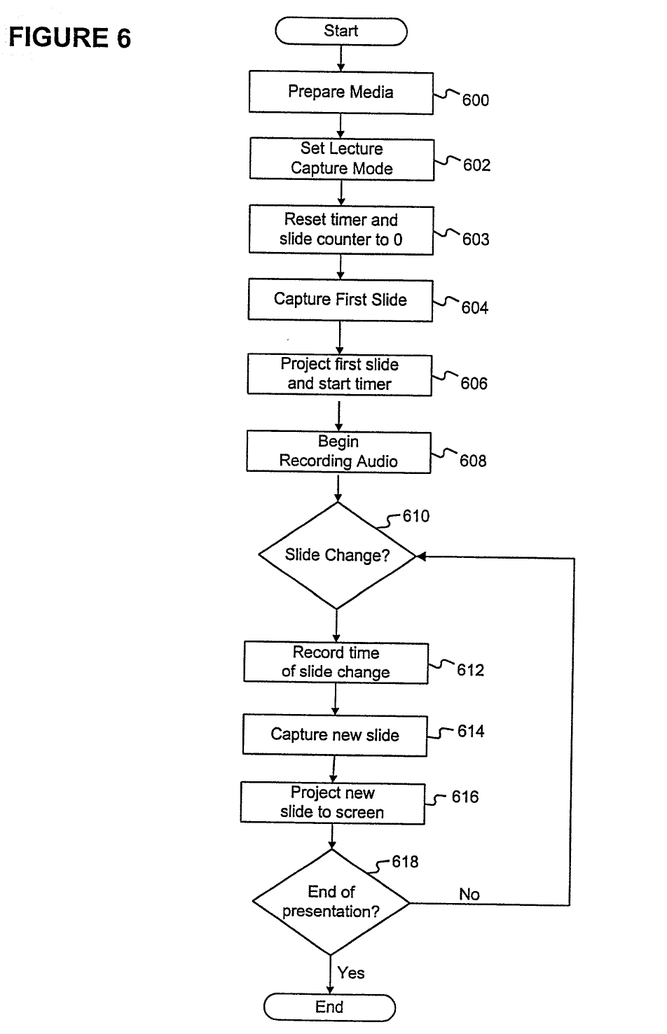

FIG. 6 depicts steps used in a method consistent with the present invention for capturing a lecture. This lecture capture mode is used to capture the basic lecture content in a format that is ready for publishing on the Internet. The system creates data from the slides, audio and timer, and saves them in files referred to as “source files.”

At the beginning of the lecture, the presenter prepares the media of choice (step 600). If using 35-mm slides, the slide carousel is loaded into the tray on the top of the projector 100. If using a computer generated presentation, the presenter connects the slide-generating computer to the SVGA input port 502 shown in the I/0 ports 500 of a projection unit 100. If using overhead transparencies or paper documents, the presenter connects the output of a multi-media projector 400 (such as the Toshiba MediaStar described above and shown in FIG. 4) to the SVGA input port 502. A microphone 116 is connected to the audio input port 506, and an Ethernet networking cable 122 is attached between the computer 102 and a network outlet in the lecture room. For ease of the discussion to follow, any of the above projected media will be referred to as “slides.”

At this point, the presenter places the system into “lecture-capture” mode (step 602). In one implementation, this is done through the use of a keyboard 108 or switch (not shown). When this action occurs, the computer 102 creates a directory or folder on the secondary storage device 310 with a unique name to hold source files for this particular lecture. The initiation of the lecture-capture mode also resets the timer and slide counter to zero (step 603). In one implementation, three directories or folders are created to hold the slides, audio and time stamp information. Initiation of lecture capture mode also causes an immediate capture of the first slide using the mirror assembly 204 (step 604) for instance. The mirror assembly 204 flips to divert the light path from the projector to the CCD 206 of the digital camera. Upon the capturing of this first slide, the digital image is stored in an image format, such as a JPEG format graphics file (a Web standard graphics format), in the slides directory on the secondary storage device 310 of the computer 102 (i.e., slides/slide01.jpg). After the capturing of the image by the CCD 206, the mirror assembly 204 flips back to allow the light path to project onto the projection screen 114. The first slide is then projected to the projection screen 114, and the internal timer 308 on the computer 102 begins counting (step 606).

Next, systems consistent with the present invention record the audio of the lecture through the microphone 116 and pass the audio signal to the audio capture card 304 installed in the computer 102 (step 608). The audio capture card 304 converts the analog signal into a digital signal that can be stored as a file on the computer 102. When the lecture is completed, this audio file is convertesd into a streaming media format such as Active Streaming Format or RealAudio format for efficient Internet publishing. In one implementation, the audio signal is encoded into the Active Streaming Format or RealAudio format in real time as it arrives and is placed in a file in a directory on the secondary storage device 310. Although, this implementation requires more costly hardware (i.e., an upgraded audio card), it avoids the step of converting the original audio file into the Internet formats after the lecture is complete. Regardless, the original audio file (i.e., unencoded for streaming) is retained as a backup on the secondary storage device 310.

When the presenter changes a slide (step 610) using the slide control 118 or by changing the transparency or document, the computer 102 increments the slide counter by one and records the exact time of this change in an ASCII file (a computer platform and application independent text format), referred to as the “time-stamp file”, written on the secondary storage device 310 (step 512). This file has, for example, two columns, one denoting the slide number and the other denoting, the slide change time. In one implementation, it is stored in the time stamp folder.

Using the mirror assembly 204 (FIG. 2), the new slide is captured into a JPEG format graphics file (i.e., slide#.jpg, where # is the slide number) that is stored in the slides folder on the secondary storage device 310. When the new slide is captured, the mirror assembly 204 quickly diverts the light from the slide image back to the projection screen 114 (step 616). If any additional slides are presented, these slides are handled in the same manner (step 618), and the system records the slide chance time and captures the new slide in the JPEG graphics file format.

At the completion of the lecture, the presenter or someone else stops the “lecture capture” mode with the keyboard 108. This action stops the timer and completes the lecture capturing process.

2) Enhancing Lecture Content

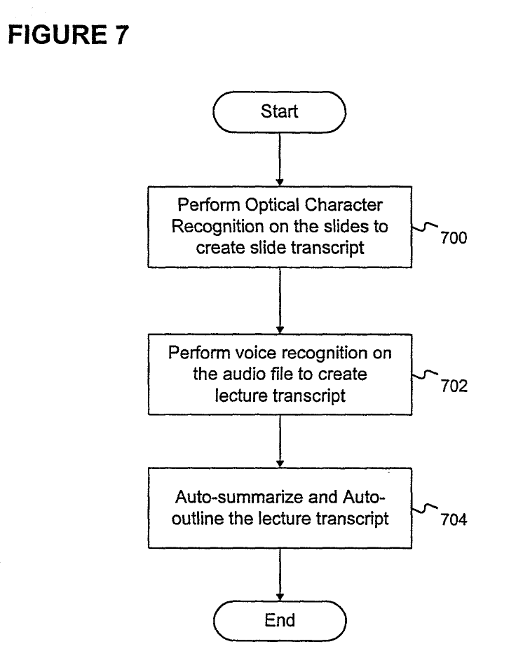

FIG. 7 depicts a flowchart illustrating a method for enhancing a captured lectured consistent with the present invention. When the lecture is complete or contemporaneous with continued capture of additional lecture content, and the system has all or a initial set of the source files described above, in one implementation it may enter “lecture enhancement mode.” In this mode, the system creates transcripts of the contents of the slides and the lecture, and automatically categorizes and outlines these transcripts. Additionally, the slide image data files may be edited as well, for example, to remove unnecessary slides or enhance picture quality.

Initially, optical character recognition (OCR) is performed on the content of the slides (step 700). OCR converts the text on the digital images captured by the CCD 206 (digital camera) into fully searchable and editable text documents. The performance of the optical character recognition may be implemented by OCR software on the computer 102. In one implementation, these text documents are stored as a standard ASCII file. Through the use of the time-stamp file, this file is chronologically associated with slide image data. Further, close caption data (if present) can be read from an input video stream and used to augment the indexing, search and retrieval of the lecture materials. A software based approach to interpreting close caption data is available from Leap Frog Productions (San Jose, Calif.) on the World Wide Web. In addition, data from native presentation materials can future augment the capability of the system to search and retrieve information from the lectures. Meta-data, including the speaker's name, affiliation, time of the presentation and other logistic information can also be used to augment the display, search and retrieval of the lecture materials. This meta-data can be formatted in XML (Extensible Markup Language, information about which is found both on the World Wide Web and can further enhance the product through compliance with emerging distance learning standards such as Shareable Courseware Object Reference Model Initiative (SCORM). Documentation of distance learning standards can be found on websites; an example of which is: elearningforum.com on the World Wide Web.

Similarly, voice recognition is performed on the audio file to create a transcript of the lecture speech, and the transcript is stored as an ASCII file along with time-stamp information (step 702). The system also allows a system administrator the capability to edit the digital audio files so as to remove caps or improve the quality of the audio using products such as WaveConvertPro (Waves, Ltd., Knoxville, Tenn.).

Content categorization and outlining of the lecture transcripts is performed by the computer 102 using a software package such as LinguistX™ from InXight of Palo Alto, Calif. (step 704). The resulting information is stored as an ASCII file alone, with time-stamp information.

3) Web Publishing

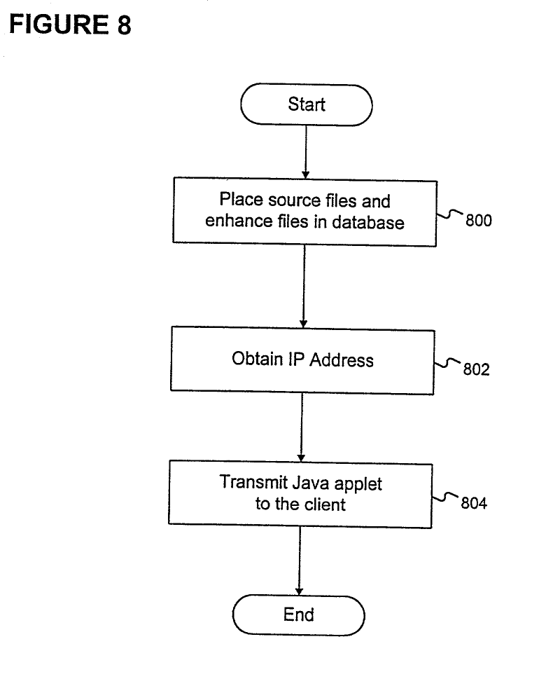

FIG. 8 is a flowchart illustrating a method for publishing a captured lecture on the Internet consistent with the present invention. After lecture capture or enhancement (step 800), the system may be set to “Web-publishing mode.” It should be noted that the enhancement of the lecture files is not a necessary process before the Web-publishing mode but simply an optimization. Also, note that for the Web-publishing mode to operate, a live Ethernet port that is Internet accessible should be connected using the current exemplary technology. Standard Internet protocols (i.e., TCP/IP) are used for networking. In this mode, all of the source files generated in the lecture capture mode, as well as the content produced in the enhancement mode, are placed in a database 318 (step 800). Two types of databases may be utilized: relational and object oriented. Each of these types of databases is described in a separate section below.

Consistent with the present invention, the system obtains a temporary “IP” (Internet Protocol) address from the local server on the network node to which the system is connected (step 802). The IP address may be displayed on the LCD panel display 106.

When a user accesses this IP address from a remote Web-browser, the system (the “server”) transmits a Java applet to the Web-browser (the “client”) via the HTTP protocol, the standard Internet method used for transmitting Web pages and Java applets (step 804). The transmitted Java applet provides a platform-independent front-end interface on the client side. The front-end interface is described below in detail. Generally, this interface allows the client to view all of the lecture content, including the slides, audio, transcripts and outlines. This information is fully searchable and indexed by topic (such as a traditional table of contents), by word (such as a traditional index in the back of a book), and by time-stamp information (denoting when slide changes occurred).

The lecture data source files stored on the secondary storage device 310 can be immediately served to the Internet as described above. In addition, in one implementation, the source files may optionally be transferred to external web servers. These source files can be transferred via the FTP (File Transfer Protocol), again using standard TCP/IP networking, to any other computer connected to the Internet. They can then be served as traditional HTTP web pages or served using the Java applet structure discussed above, thus allowing flexibility of use of the multimedia content.

### Use of the Captured Lecture and the Front-End Interface

The end-user of a system consistent with the present invention can navigate rapidly through the lecture information using a Java applet front-end interface. This platform-independent interface can be accessed from traditional PC's with a Java-enabled Web-browser (such as Netscape Navigator™ and Microsoft Internet Explorer™) as well as Java-enabled Network Computers (NCs).

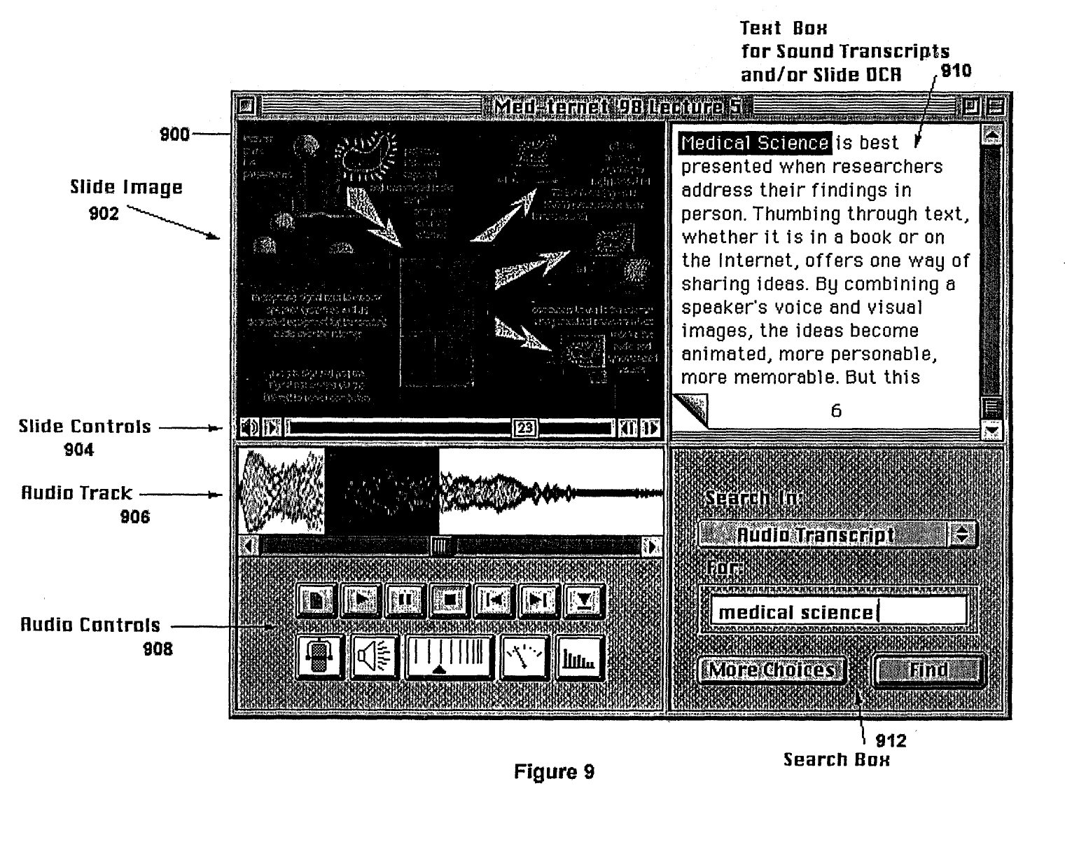

FIG. 9 shows a front-end interface 900 consistent with the present invention. The front-end interface provides a robust and platform-independent method of viewing the lecture content and performing searches of the lecture information. In one implementation, the interface consists of a main window divided into four frames. One frame shows the current slide 902 and contains controls for the slides 904, another frame shows the audio controls 908 with time information 906, and a third frame shows the transcript of the lecture 910 and scrolls to follow the audio. The fourth frame contains a box in which the user can enter search terms 912, a pop-up menu with which the user can select types of media they wish to search, and a button that initiates the search. Examples of search methodologies include: chronological, voice transcript, slide transcript, slide number, and keyword. The results of the search are provided in the first three frames showing the slides, the audio and the transcripts. In another implementation consistent with the present invention, another window is produced which shows other relevant information, such as related abstracts.

### Description of the Database Structure

Before the source files generated in the lecture capturing process can be published in a manner that facilitates intelligent searching, indexes to the source files must be stored in a database. The purpose of the database is to maintain links between all source files and searchable information such as keywords, author names, keywords in transcripts, and other information related to the lectures.

There are two major methods for organizing a database that contains multiple types of media (text, graphics and audio): object-oriented and relational. An object-oriented database links together the different media elements, and each object contains methods that allow that particular object to interact with a front-end interface. The advantage of this approach is that any type of media can be placed into the database, as long as methods of how this media is to be indexed, sorted and searched are incorporated into the object description of the media.

The second method involving a relational database provides links directly to the media files, instead of placing them into objects. These links determine which media elements are related to each other (i.e., they are responsible for synchronizing the related audio and slide data).

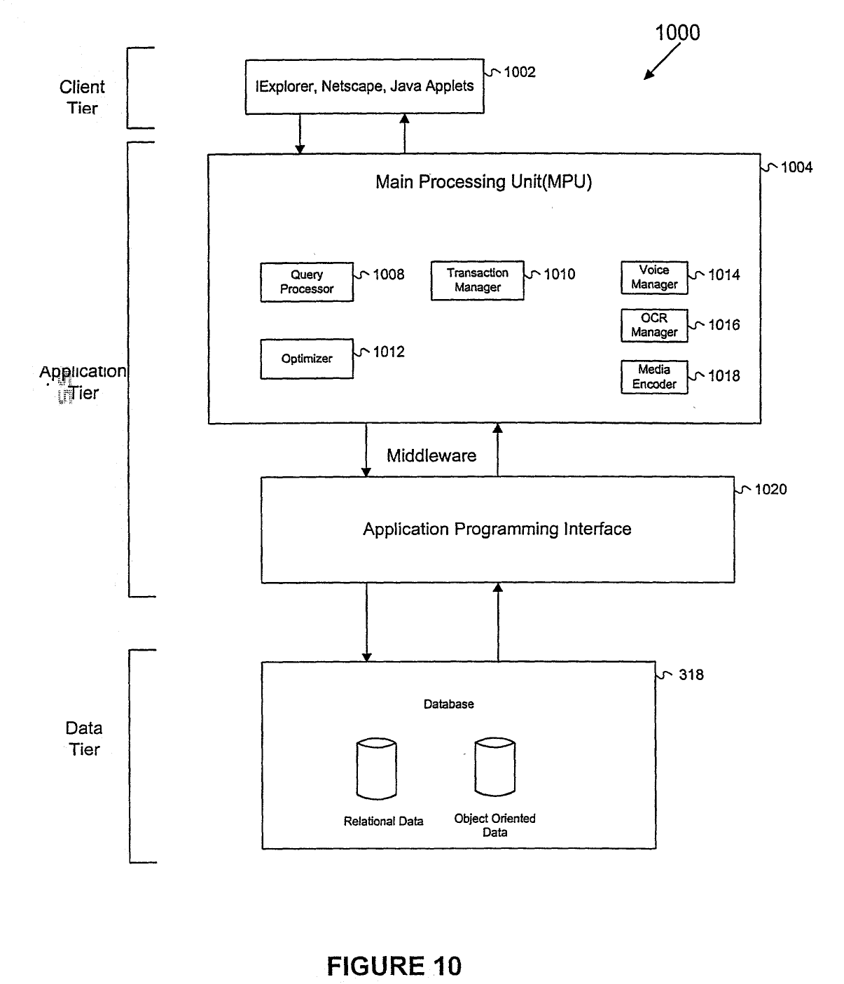

FIG. 10 shows a schematic of a three-tier architecture 1000 used to store and serve the multimedia content to the end-user. As shown in FIG. 10, the database 318 comprises part of the three-tier architecture 1000. The database 318 (labeled as the “data tier”) is controlled by an intermediate layer instead of directly by the end-user's interface 1002 (labeled as the “client tier”). The client is a computer running a Web-browser connected to the Internet. The intermediate layer, labeled as the “application tier,” provides several advantages. One advantage is scalability, whereas more servers can be added without bringing down the application tier. Additionally, the advantage of queuing allows requests from the client to be queued at the application tier so that they do not overload the database 318. Finally, there is increased compatibility. Although the application tier and front-end are Java based, the database 318 can communicate with the application tier in any manner which maximizes performance. The method of communication, protocols used, and types of databases utilized do not affect the communication between the business logic and the front-end.

FIG. 10 also shows how the application tier consists of a Main Processing Unit (MPU) 1004 and middleware 1020. On the MPU 1004 resides the custom Java code that controls query processing 1008, manages transactions 1010 and optimizes data 1012. Additionally, this code performs OCR 1014 and voice recognition 1016 and encodes the media 1018. The middleware 1020 provides a link between the custom Java code and the database 318. This middleware 1020 already exists as various media application programming interfaces (APIs) developed by Sun Microsystems, Microsoft, and others. The middleware 1020 abstracts the custom Java code from the database 318.

The end-user or client interacts with the MPU 1004 within the application tier. In addition, information entering the database 318 from the “lecture-capture mode” of the system enters at the application tier level as well. This information is then processed within the MPU 1004, passed through the middleware 1020, and populates the database 18.

### Alternative embodiments

There are many different methods of implementing a system that performs functions consistent with the present invention. Several alternative embodiments are described below.

1) Separation of the Mirror Assembly from the Projection Device and Computer

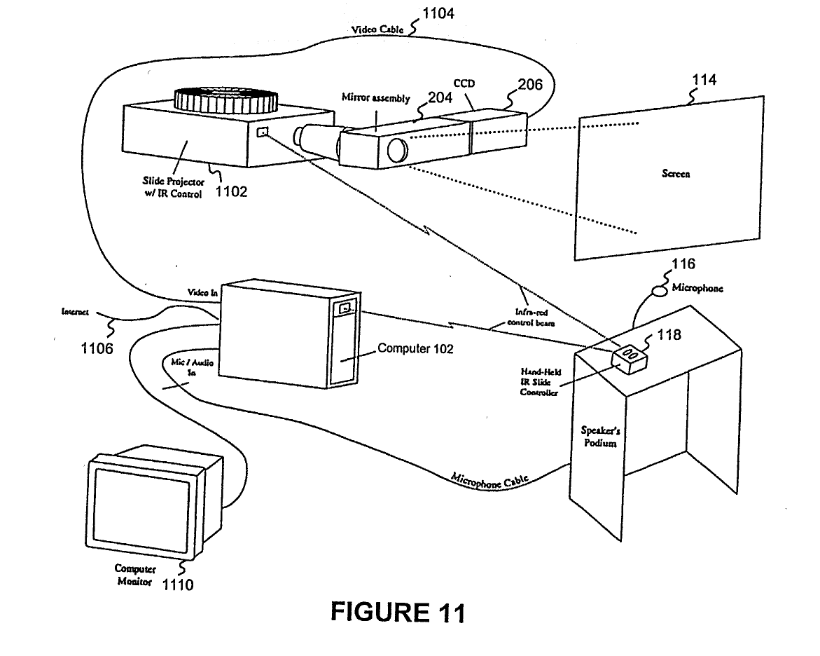

FIG. 11 depicts a lower-cost and even more modular way of providence the lecture-capturing functionality involving the separation of the mirror assembly 204 and CCD 206 from the projection device. In this embodiment, the mirror assembly 204 and CCD 206 are in a separate unit that snaps onto the lens of the 35-mm slide projector 1102. As shown in FIG. 11, the mirror assembly 204 and CCD 206 is connected by video cable 1104 to the computer 102, which sits in a separate box. This connection allows the computer 102 to receive digital video image data from the CCD 206 and to control the action of the mirror 204 via the solenoid 202 (shown in FIG. 2). The infrared beam from the slide controller 118 signals a slide chance to both the slide projector 1102 and the computer 102. Both the infrared sensors on both devices are configured to receive the same IR signal so that the slide controller 118 can control both devices. For instance, the slide projector 1102 may be purchased with a slide controller 118, in which case the slide projector 1102 will already be tuned to the same infrared frequency as the slide controller 118. An infrared sensor in the computer 102 may be built or configured to receive the same infrared frequency emitted by the slide controller 118. Such configuration of an infrared sensor tuned to a particular frequency is well known to those skilled in the art. Additionally, a computer monitor 1110 is used in place of the LCD display on a single unit. A laptop computer, of course, can be used instead of the personal computer shown. The advantage of this modular setup is that once the appropriate software is installed, the user is able to use any computer and projection device desired, instead of having them provided in the lecture-capturing box described above.

For capturing computer-generated presentations, the mirror assembly is not used and the video signal and mouse actions from the user's slide-generating computer pass through the capture computer before going to the LCD projector. This enables the capture computer to record the slides and change times.

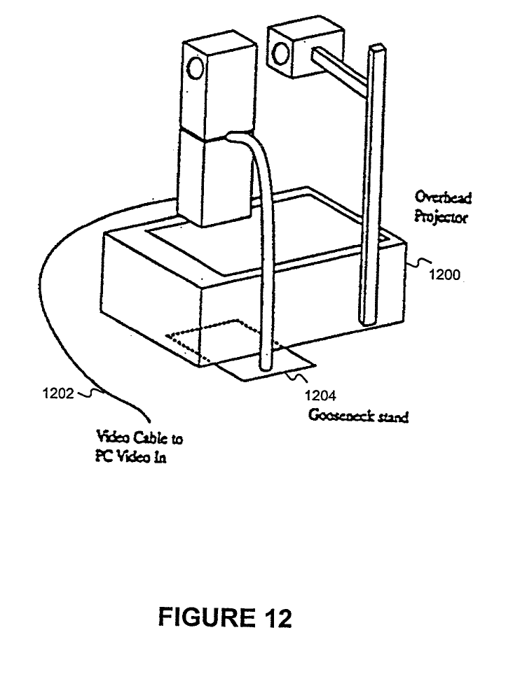

FIG. 12 shows another implementation using, the connection of a separate CCD 206 and mirror assembly 204, described above, to a standard overhead projector 1200 for the capture of overhead transparencies. A video cable 1202 passes the information from the CCD 206 to the computer 27. A gooseneck stand 1204 holds the CCD 206 and mirror assembly 204 in front of the overhead projector 1200.

### Alternate Slide Capture Trigger

With the use of a Kodak Ektapro Slide Projector (Kodak, Rochester, N.Y.) which can either be incorporated into device 100 or used as a stand-alone slide projector 1102, an alternative method of communicating the status of the slide projector to the computer 102 uses the P-Com protocol (Kodak, Rochester, N.Y.). The P-Com protocol is communicated between the slide projector and the computer 102 over an RS-232 interface that is built into the Ektapro projector. The information obtained from the projector provides the computer 102 with the data signaling that a slide change has occurred whereupon the computer will then digitally capture the slide. This alternative approach alleviates the need for detecting signals from the infrared controller 118 and IR sensor 104 or the wired slide controller.

### Alternate Front-End Interfaces

Although the front-end interface described above is Java-based, if the various modes of operation are separated, alternate front-end interfaces can be employed. For example, if lecture-capture is handled by a separate device, its output is the source files. In this case, these source files can be transferred to a separate computer and served to the Internet as a web site comprised of standard HTML files for example.

In another implementation, the front-end interface can also be a consumer-level box which contains a speaker, a small LCD screen, several buttons used to start and stop the lecture information, a processor used to stream the information, and a network or telephone connection. This box can approach the size and utility of a telephone answering machine but provides lecture content instead of just an audio message. In this implementation, the lecture content is streamed to such a device through either a standard telephone line (via a built-in modem for example) or through a network (such as a cable modem or ISDN). Nortel (Santa Clara, Calif.) provides a “Java phone” which can be used for this purpose.

### Alternate Implementation of Application Tier

The system described in the Main Processing Unit (1004) and the Application Programming Interface (1020) can be programmed using a language other than Java, e.g., C, C++ and/or Visual Basic Languages.

### Alternate Optical Assembly for Image Capture

Another implementation of the present invention replaces the mirror assembly 204 with a beam splitter (not shown). This beam splitter allows for slide capture at any time without interruption, but reduces the intensity of the light that reaches both the digital camera and the projection screen 114. If a beam splitter is used, redundancies can be implemented in the slide-capturing stage by capturing the displayed slide or transparency, for example, every 10 seconds regardless of the slide change information. This helps overcome any errors in an automated slide change detection algorithm and allows for transparencies that have been moved or otherwise adjusted to be recaptured. At the end of the lecture, the presenter can select from several captures of the same slide or transparencies and decide which one should be kept.

### System Diagnosis

In one implementation consistent with the present invention, the user can connect a keyboard and a mouse, along, with an external monitor to the SVGA-out port 504. This connection allows the user access to the internal computer 102 for software upgrades, maintenance, and other low-level computer functions. Note that the output of the computer 102 can be directed to either the LCD projection device or the LCD panel 106.

### Wireless Communications

In one implementation consistent with the present invention, the network connection between the computer and the Internet can be made using wireless technology. For example, a 900 MHz connection (similar to that used by high quality cordless phones) can connect the computer 102 to a standard Ethernet wall outlet. Wireless LANs can also be used. Another option uses wireless cellular modems for the Internet connection.

### Electronic pointer

In another implementation, an electronic pointer is added to the system. Laser pointers are traditionally used by presenters to highlight portions of their presentation as they speak. The movement of these pointers can be tracked and this information recorded and time-stamped. This allows the end-user to search a presentation based on the movement of the pointer and have the audio and video portion of the lecture synchronized with the pointer.

Spatial positional pointers can also be used in the lecture capture process. These trackers allow the system to record the presenter's pointer movements in either 2-dimensional or 3-dimensional space. Devices such as the Ascension Technology Corporation pcBIRD™ or 6DOF Mouse™ (Burlington, Vt.), INSIDETRAK HP by Polhemus Incorporated (Colchester, Vt.), or the Intersense IS 300 Tracker from Intersense (Cambridge, Mass.) can be used to provide the necessary tracking capability for the system. These devices send coordinate (x, y, z) data through an RS-232 or PCI interface which communicates with the CPU 306, and this data is time-stamped by the timer 308.

### Separation into Different Units

In one embodiment consistent with the present invention, the system is separated into several physical units, one for each mode or a subset combination of modes (i.e., lecture capture, enhancement and publishing). A first physical unit includes the projection device and computer that contains all of the necessary hardware to perform the lecture-capturing process. This hardware can include the mirror assembly, the CCD digital camera, if this embodiment is used, a computer with video and audio capturing ability, an infrared sensing unit, and networking ability. In this implementation, the function of this unit is to capture the lecture and create the source files on the secondary storage of the unit. This capture device contains the projection optics and can display one or more of 35-mm slides, a computer generated presentation, overhead transparencies and paper documents.

In this implementation, the lecture enhancement activities are performed in a second separate physical enclosure. This separate device contains a computer with networking ability that performs the OCR, voice recognition and auto-summarization of the source files generated in the lecture capturing process.

Finally, a third physical enclosure provides Web-publishing function and contains a computer with network ability, a database structure and Internet serving software. The second and third functions can be combined in one physical unit, the first and third functions can be combined in one physical unit or the first and second functions can be combined in one physical unit, as circumstances dictate.

In this modular design, several categories of products can be envisioned. One provides lecture capturing ability only and requires only the lecture-capturing devices. This system is responsible for the creation and serving of the generated source files. Another implementation provides lecture capturing and Web serving and only requires the lecture-capturing devices and the Web-publishing devices. Yet another implementation adds the lecture-enhancement device to the above setup and also makes the lecture transcripts and summaries available to the Web. In addition to the modularization of the different tasks as described above, modularization with respect to physical components (different products), with distributed task functions, can be achieved. For instance, several lecture capture units can be networked or otherwise connected to a centralized enhancement and publishing, or just publishing unit.

### Electronic Capture Embodiments

The modular approach facilitates additional embodiments where the presentation is developed at least regarding the slides as a computer generated presentation using available software such as PowerPoint®, etc. In these embodiments, a chip set such as made available from companies such as PixelWorks which allows for the ability to auto-detect the video signal and also provides digitization of the signal in a means which is appropriate to the resolution and aspect ratio and signal type (video verses data). The CPU and the digitization circuitry can be provided on a single chip along with a real-time operating system and web-browser capability or on separate chips. Four embodiments with varying degrees of modularity and functionality are described below. Furthermore, Pixelworks offers chip sets which provides a system on a chip by incorporating a Toshiba general purpose microprocessor, an ArTile TX79 on the same chip as the video processing circuits (pixelworks.com/press on the World Wide Web). Leveraging the general purpose microprocessor; embodiments containing this or similar devices can perform the following functions:

Control and/or communicate with external devices such as hard drives or other digital storage media using USB, Ethernet and or IEEE 1394 connectivity.

Execute software which can either read file formats (such as Microsoft PowerPoint®, Microsoft Word®, Internet browsers, etc.) which are commonly used in presentations.

Execute software to read a file in an intermediate file format which may be a proprietary 'transfer format' which is compatible with Microsoft PowerPoint®, Word, Internet browsers, etc.) which are commonly used in presentations. Companies that produce such file translation software include DataViz (dataviz.com on the World Wide Web).

Interpret data from an input stream (provided for example by IEEE 1394, USB, Ethernet, or Wireless network connectivity), allowing processing of data for either immediate display and/or storage in part or in whole for later viewing.

1) Projector Embodiment

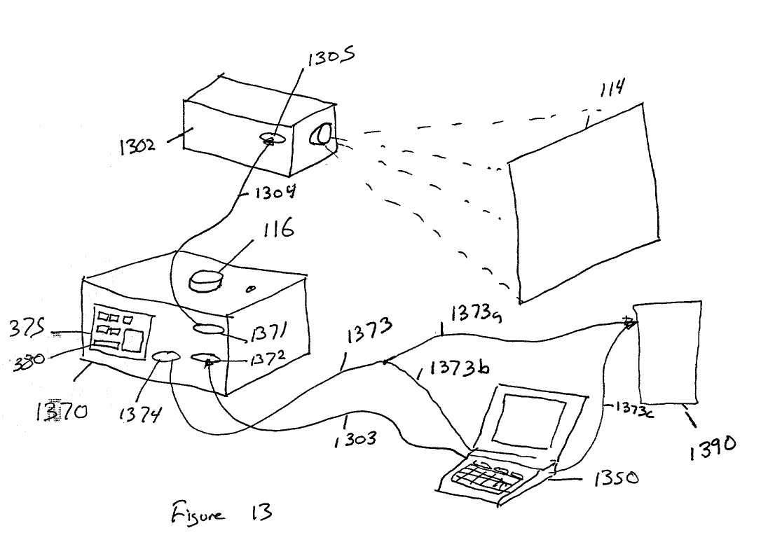

The first of these embodiments, shown in FIG. 13 is standard image (e.g., slide and/or video) projector 1302 with an intermediary unit 1370 placed between the projector 1302 and the source of the projected images, e.g., a general purpose computer 1350. The intermediate unit 1370 completes the media processing and contains either a USB port 1374 to communicate with the computer 1350 and possibly an analog modem and Ethernet to communicate directly with a server 1390. The projector 1302 associated with this embodiment can be any commercial or proprietary unit that is capable of receiving VGA, SVGA, XGA or SXGA and/or a DVI input, for instance. The input 1305 to the video projector is received via cable 1304 from the intermediate unit 1370 from an associated output port 1371. The intermediate unit 1370 receives its input at interface 1372 via cable 1303 from the general purpose computer 1350 or other computer used for generating the presentation. The intermediate unit 1370 also contains an omni-directional microphone 116 and audio line input to be used concurrently or separately as desired by the user. The intermediate unit 1370 functions to capture the presentation through the computer generated slides, encoded time-stamp and capture the audio portion of the presentation. The captured data can then be stored in removable media 1380 or transferred via USB or other type of port from the intermediate units output 1372 by cable 1373b to the computer 1350. This aspect can eliminate the need for storage in the intermediate unit 1370 and can use more reliable flash memory. The computer 1350 or other type of computer receives the processed media from the intermediate unit 1370 and transfers the data via cable 1373a to the Web-server through its connection to the net. Alternatively the intermediate unit 1370 can connect directly to the media server 1390 via cable 1373a as described earlier.

The media server 1390 running standard media server software such as Apple Quicktime™ , RealNetworks RealSystem Server™ or Microsoft Media Server, streams the data with a high bandwidth connection to the Internet. This process can occur both as a simulcast of the lecture as well as in an archive mode with transfer occurring after the event has transpired. Such arrangement with the computer 1350 eliminates the need for an Ethernet card and modem built into the intermediate unit 1370 since most general purpose computers already have this functionality.

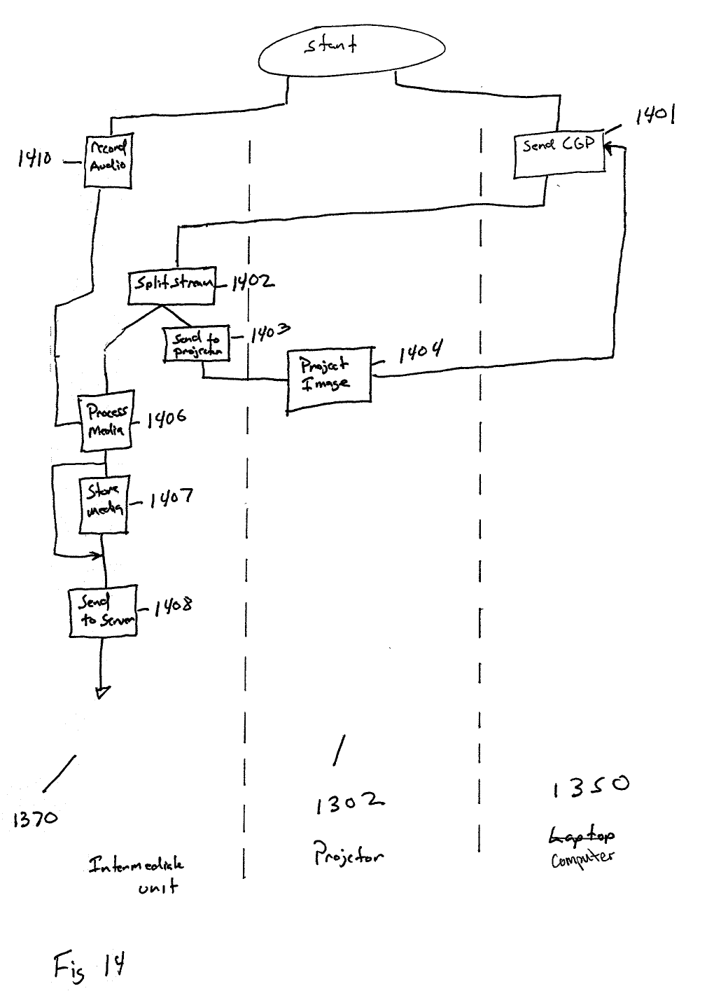

FIG. 14 shows a flow chart with each function arranged in an associated component. The components being a general purpose computer or other type of computer 1350, an image projector 1302 and an intermediate unit 1370. At the beginning of a presentation, the lecturer uses the computer 1350 to send a computer generated presentation, i.e., an image or series of images or slides, to the intermediate unit 1370 in step 1401. Simultaneously with this process the intermediate unit in step 1410 begins to record the audio portion of the live presentation. In step 1402 in the intermediate unit 1370, a signal containing the image is split into two signals, the first of which is processed with the recorded audio in step 1406 and is stored in step 1407 in the intermediate unit 1370, or alternatively sent directly to the server in step 1408. In step 1403, the second of the split signals is sent to the projector in step 1403, and is displayed by the projector 1302 in step 1404. The process is began again at step 1401 when the lecture sends a new computer generated image. The audio is recorded continuously until the presentation is complete.

In splitting the image signals sent from the personal computer 1350 at step 1401 the present embodiment facilitates two different methods. In the first method using an image signal splitter (e.g., a Bayview 50-DIGI, see on the World Wide Web baytek.de/englisch/BayView50.htm), the image signal is split into a digital 24 bit RGB (red, green, blue) for media processing and an analog RGB image signal sent to the projector 1302. However, if the projector is capable of receiving digital RGB image signals then a image signal splitter such as a Bayview AD1 can be used which produces two digital outputs, one for processing and one for projection.

2) Digital Output Projector

While the primary thrust is to permit a standard, non-customized computer 1350 to permit a presenter to use his own laptop, for instance, it is possible that the functions of the intermediate unit 1370 be incorporated in the general purpose computer 1350 through software, firmware and hardware upgrades.

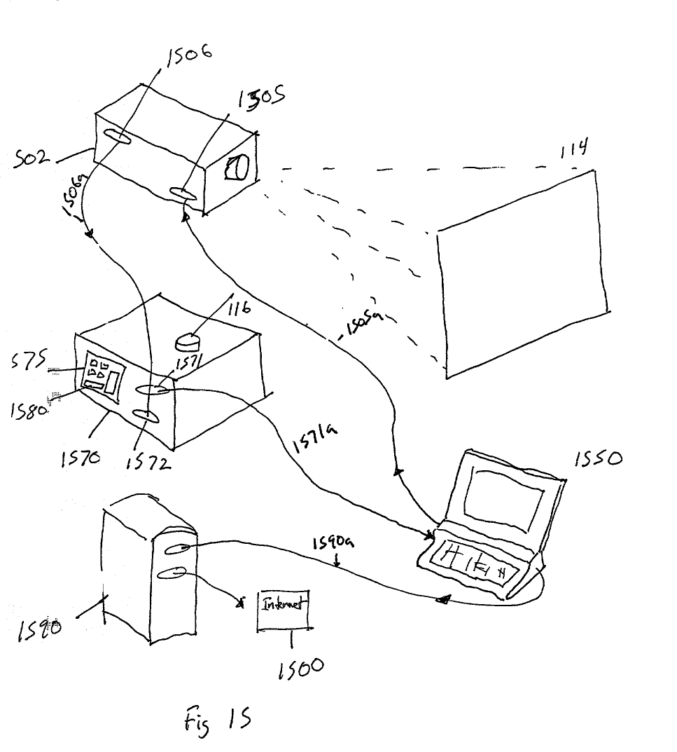

In a second alternative embodiment such as shown in FIG. 15 for use with computer generated presentations, an image projector 1502 contains a digital output and formatting for output via USB or Firewire (IEEE 1394). A general purpose personal computer 1550 or other type of computer used for generating the presentation supplies the computer generated presentation to the projector 1502 through an input port 1505 via cable 1505a on the projector that has the capability of receiving VGA, SVGA, XGA or SXGA and/or a DVI input for instance. Though the USB or Firewire (IEEE 1394 interface) interface 1506, via cable 1505a, the projector 1502 communicates with an intermediate unit 1570 at interface 1572 which captures the computer generated presentation as well as the audio portion of the presentation through an omni-directional microphone 116 and/or audio input. The output from the intermediary unit 1570 is in the form of the raw media format and supplied to the general purpose computer 1550 via USB or Firewire interface 1571 and cable 1571a where the media is processed using custom software for media conversion and processing or custom hardware/software in the laptop computer. The media is processed into HTML and/or streaming format via the software/hardware and supplied to the media server 1590 via cable 1590a which in turn streams the media with high bandwidth to the Internet 1500. This system utilizes the capabilities of the computer 1550 used in generating the presentation to process the media, with only the addition of software or some custom hardware. The intermediate unit 1570 also has a removable storage media 1580 and presentation capture controls 1575 that adjusts certain parameters associated with the lecture capture. However, the intermediate unit 1570 can be connected directly to the server 1590.

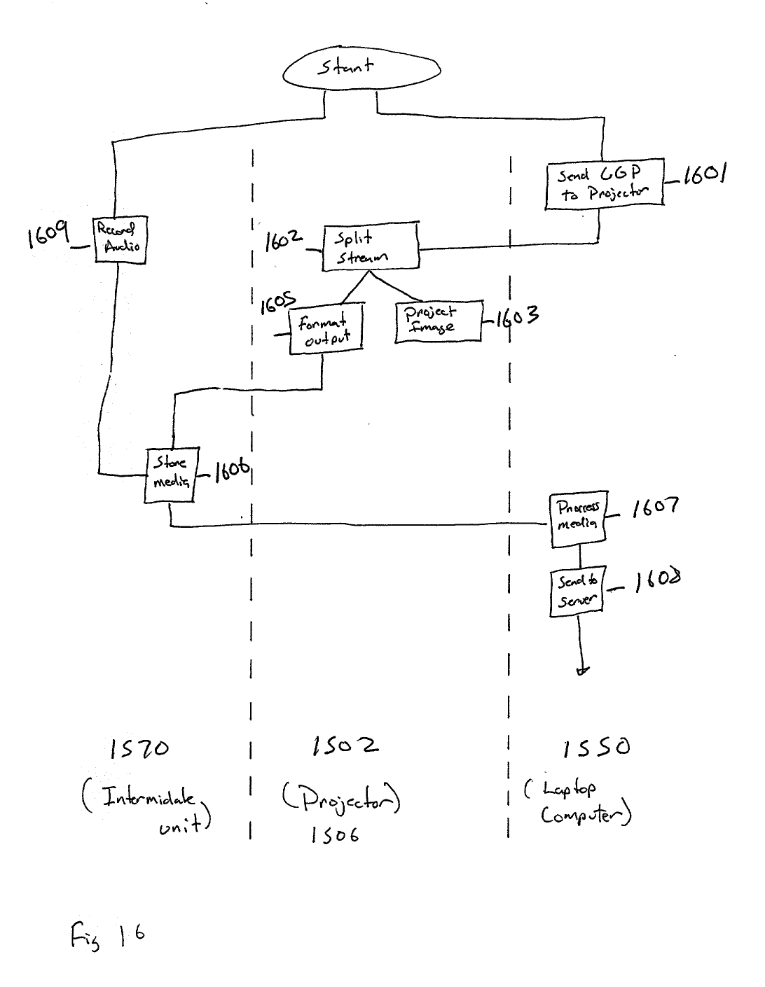

FIG. 16 is a flow chart representing different functions and components of the lecture capturing system for the embodiment shown in FIG. 15 and discussed above. At the start the presenter via the computer 1550 sends a computer generated presentation, e.g., images, to the projector at step 1601. As in the previous embodiment, the image signal is split at step 1602 into two image signals, the first of which is formatted, if necessary, to digital form which also can be carried out using the signal splitting components discussed above. The signal is then stored at step 1606 along with the audio portion of the live presentation which is recorded in step 1609. The raw data is then transferred back to the computer 1550 for media processing in step 1607 where synchronization of the recorded audio portion and the images is also accomplished. The formatted information is then sent to a server in step 1608.

3) Projector with Media Processor

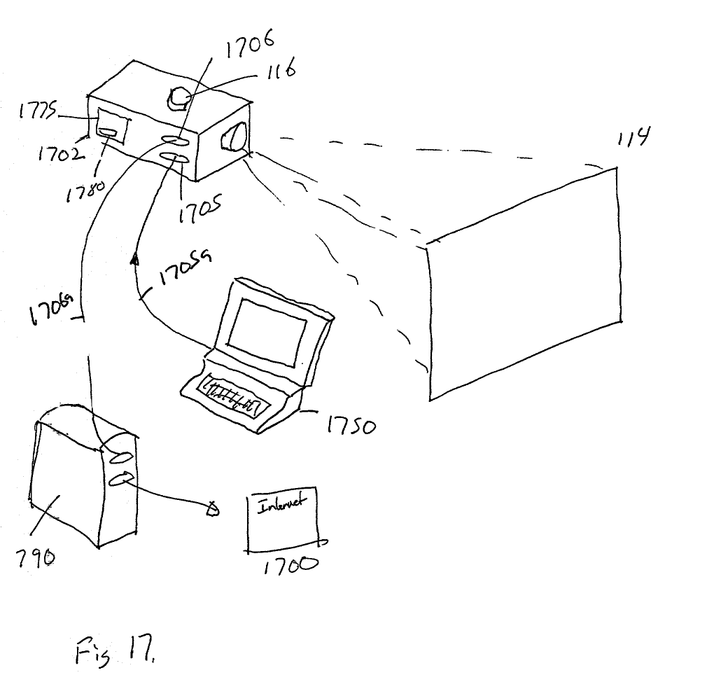

A third embodiment, FIG. 17, for use with computer generated presentations is one in which the projector 1702 contains digital output and formatting for output via USB or Firewire and further contains the media processor which processes the media into HTML and/or streaming format or other Internet language, the projector 1702 communicates with a media server 1790 through an Ethernet interface 1706 via cable 1706a from which the media is streamed to a connection to the Internet 1700. Again this system would be capable of producing a simulcast of the lecture as well as storing in an archive mode. This embodiment as with the previous embodiments allows the use of removal media 1780 in the projector 1702. The projector 1702 also contains a control panel 1775 for controlling various parameters associated with capturing the presentation. Alternatively, the control panel can be created in software and displayed as a video overlay on top of the projected image. This overlay technique is currently used on most video and/or data projectors to adjust contrast, brightness and other projector parameters. The software control panel can thus be toggled on and off and controlled by pressing buttons on the projector or through the use of a remote control which communicates with the projector using infrared or radio frequency data exchange.

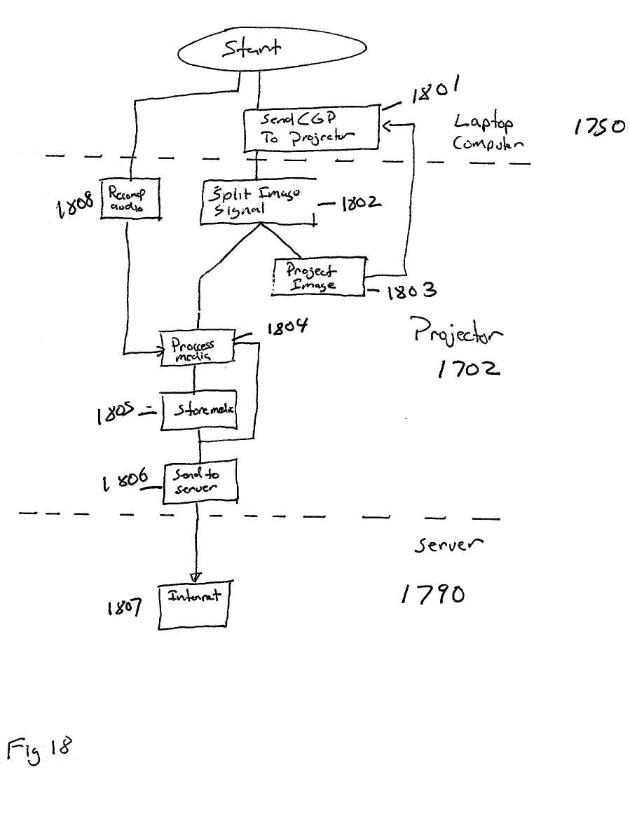

FIG. 18 is a flow chart showing the different functions and components of the live presentation capture system for the embodiment shown in FIG. 17 and discussed above. The individual components in this embodiment are a computer 1750, a projector 1702 and a network server 1790. At the start of the presentation, the lecturer using laptop computer sends a computer generated presentation, i.e., image, to the projector. The image signal is then divided in step 1802 as discussed previously with one signal being used to project the image in step 1803, and the other signal being processed along with the audio portion of the live presentation hat was recorded at step 1808, in step 1804. The processed media then may be stored using fixed memory or removable memory media in step 1805. As discussed above, processed media could also be directly sent to the server 1790 through step 1806 without implementing the storage step 1805. The server 1790 in step 1807 connects to the network or Internet such that it can be accessed by a client.

4) Projector with Enhancement and Publishing Capabilities

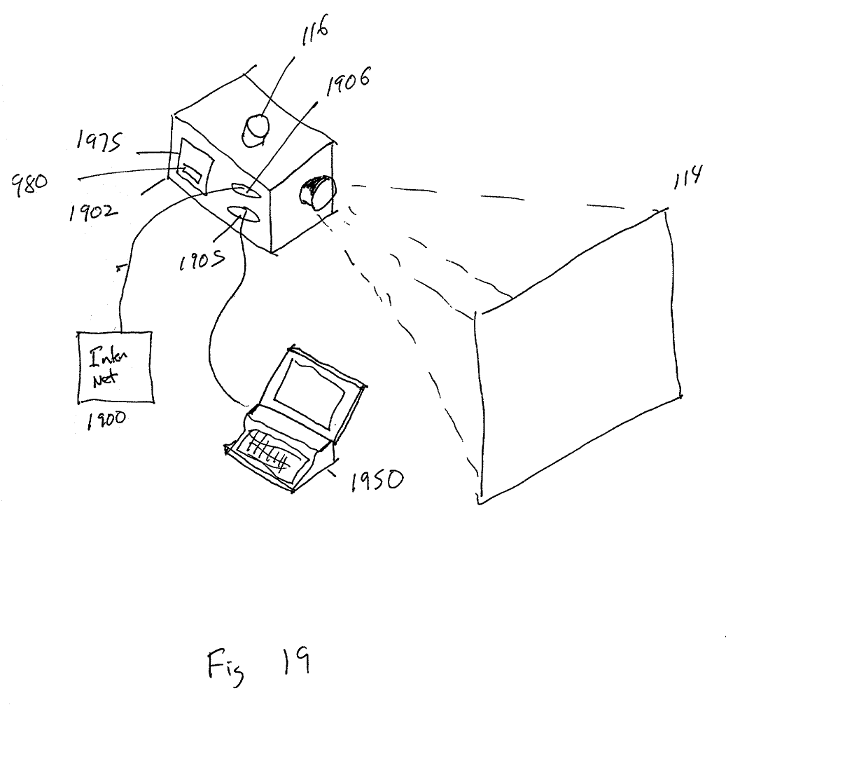

A fourth embodiment associated with computer generated presentations as seen in FIG. 19 is a projector 1902 that contains all the hardware necessary to capture and serve the electronic content of the live presentation through a connection 1906 to the network through Ethernet or fiber connection, as such the projector 1902 captures the video content, through its connection via interface 1905 and cable to a personal computer 1950 or other type of computer and the audio content via omni-directional microphone 116 or audio line input, process the media into HTML and/or streaming format and further act as a server connecting directly to the Internet 1900. The projector 1902 also contains a control panel 1975 which controls various parameters associated with capturing the presentation as well as removable media 1980 when it is desired to store the presentation in such a manner.

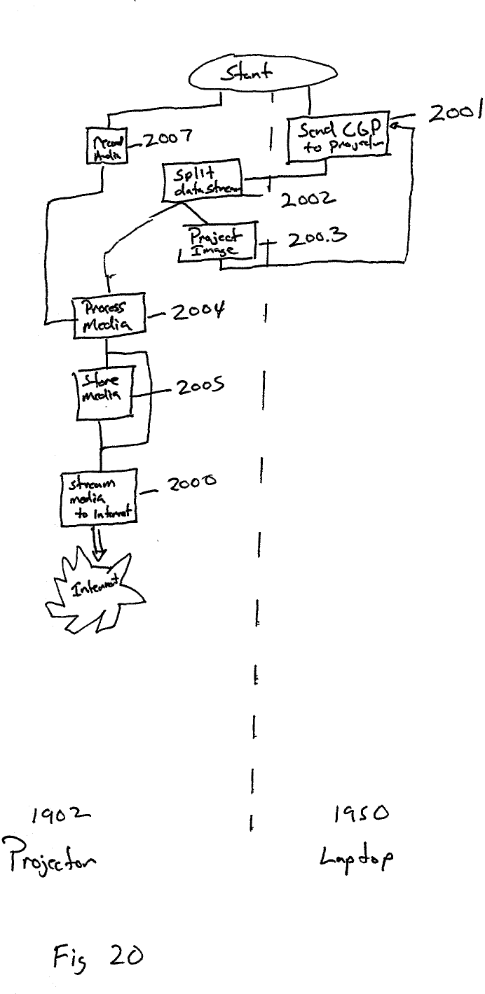

FIG. 20 is a flow chart showing the functions and components used to capture a live presentation according to the above embodiment shown in FIG. 19. At the start of the presentation the lecturer, using the computer 1950, sends a computer generated presentation to the projector 1902. Again, as discussed in detail above, after step 2001 the data from the image signal is split into two signals in step 2002, the second signal being used to project the image in step 2003 such that it can be viewed by the audience. The first signal is processed and synchronized with the audio portion of the live presentation which was recorded in step 2007, in step 2004. The processed media can then be stored in step 2005 and/or streamed directly to the Internet step 2006. With the functions integrated all into one projector 1902, the projector 1902 would be capable of functioning as each of the individual components, and such various interfaces and capabilities would be incorporated into the projector.

Various inputs associated with a standard projector would be incorporated, including but not limited to digital video image and/or VGA into the integrated projector. Outputs allowing the integrated projector to function with a standard projector thus expanding its versatility would also include a digital video image output for highest quality digital signal to the projector. VGA output would also be integrated into the integrated projector. USB connectors, as well as Ethernet and modem connectors, an audio input and omni-directional microphone are also envisioned in the integrated projector 1902. As the integrated projector 1902 is capable of many different functions using different sources, input selection switches are also envisioned on the integrated projector, as well as other features common in projectors such as remote control, and a variety of interfaces associated with peripheral elements.

The capture of the presentation in the previous four embodiments contain similar processes. The presenter (or a someone else) connects the personal computer (e.g., laptop) to the integrated projector or the in-line of intermediate unit. The system is configured, through available switches, depending on the source, to capture characteristics unique to the source of the presentation. The audio is captured and converted to digital through an A and D converter along with the images if the digital output from the projector is not available. The image signal is split, the image is displayed then compressed into a standard file format, (e.g., JPEG, MPEG) the synchronization of audio and images occurs during the digitization and formatting processes, the media processing allows for compressions of images via a variety of methods including color palette optimization, imagery sizing and image and audio compression as well as indexing. Compression for use of the data in an Internet stream format also occurs during processing. During media processing other data can also be entered into the system, such as speaker's name, title of the presentation, copyright information and other pertinent information, as desired. The information captured is then transferred to the server allowing it to be streamed to clients connected to a network, Internet or Intranet. As discussed in the above embodiments, the media can be served directly from one of the intermediate units or projectors, or it can be transferred to an external server which exists as part of an Internet or is directly connected to the Internet. When the data is made available immediately over an IP connection in either a uni- or bi-directional manner, the device can be used for real-time teleconferencing. As such, these embodiments are in harmony with other methods and systems for capturing a live presentation as discussed earlier and as such can include other applicable features presented in this disclosure, as appropriate. More or less modularization of the system is envisioned in response to varying needs and varying user assets.

5) Use of Digital Media with Embedded Processor/Operating systems

Another embodiment involves the use of digital media which contain microprocessors and independent operating systems. One representative device, The Mine from Teraoptix (mineterapin.com/terrapin on the World Wide Web) contains the Linux operating system, digital storage (12 gigabytes of storage) and Ethernet, USB, and IEEE 1394 connectivity. This device also allows for Internet connectivity for file uploads and downloads. Coupling this device with the different embodiments can allow for a solution which provides (or replicates the digital audio recording functionality) as well as providing image storage through connection of the projector which may be equipped with a USB, Ethernet, or IEEE 1394 output).

6) Software Only Capture Embodiment

The laptop or presentation computer in parallel with running the presentation can capture the presentation. In order to affect lecture capture in a software based solution, the following provide the components of the software solution enabling this embodiment:

i. Generation of time-stamps;

ii. Visual media processing

iii. Audio capture and processing;

iv. Synchronization of media;

v. Addition of search methodologies to on-line presentations; and

vi. Placement of materials on the web and use of emerging distance learning standards.

We will refer to the software involved in the capture process as the capture application (Calif.). The CA can run on the presentation system or on the server (or can partially run on both). The software can be written in standard personal computer programming languages such as C, C++, JAVA, or other software languages.

Each of the above items is discussed below:

For item (i), generation of time-stamps, several approaches can be invoked namely:

a. Use of the Microsoft COM protocol. When the presentation makes use of applications which support COM (e.g., the Microsoft Office Suite), the applications can communicate back to the CA all of the operations and functions (events) which were preformed using the application during a presentation. By associating each event with a corresponding time-stamp, the CA can create a time-line of events associated with the media-allowing for the storage and transmission of a presentation.

b. Use of digital audio to generate time-stamp data. Events during a presentation can be punctuated by changes in a presenter's audio. For example, a presenter may pause between the presentations of different media elements and/or the presenter's speech may change in pitch at the end of the display of a media element. Furthermore, the presenter may use ‘cues’ which signal changes in media (such as a statement, ‘on the next slide’). Through signal processing techniques and/or speech recognition, one can abstract these events and create a time-stamp/event log.

c. Use of changes in the visual elements. Through the use of digital image processing software, time-stamp data can be created. The digital image processing techniques can identify movement of the pointer (associated with mouse movement) over particular regions of the image—indicating changes in the presentation. Other techniques involve changes in color palette of images, and/or image file size.

d. Monitoring keyboard and mouse functions. Through the use of software which provides a time-stamp when an event occurs such as mouse clicks, movement, as well as keyboard key depression, a time-stamp log can be created.

e. For use of PowerPoint slides presentations, one can open existing PowerPoint presentations using Microsoft PowerPoint 2002; the software provides the ability to capture PowerPoint presentations for broadcast on the Internet. This functionality allows for the conversion of the presentation into a Microsoft Media Player format.

f. Any combination of the above techniques

With each of the above time-stamp generation, the presentation computer can initiate capture either locally on the presentation machine itself and/or on the server.

ii. Visual Media Processing.

Two methods for image capture on the presentation computer are possible and can either be used singular or in combination.

a. Local Capture of Presentation Images. An example of local image capture makes use of software techniques deployed by companies such as TechSmith for screen capture (techsmith.com on the World Wide Web) which can capture images through the use of trigger events or on a timed basis.

b. Capture of Images through File Conversion. Alternatively, the native files used during a presentation can be converted into web-ready formats (e.g., JPEG) on the presentation machine, server, or any intermediary device containing a microprocessor.

c. Video Capture. Use of a web cam (such as produced by 3Com) or other digital video source with a standard computer interface (e.g., USB, IEEE 1394) can provide imaging of the presenter which can be combined with the presentation.

iii. Audio Capture and Processing. Audio capture can occur through the use of several options including use of audio capture technology available on many computers in either hardware that exists on the motherboard or is provided with the adition of a digital audio acquition card from suppliers such as Creative Labs. Alternatively, a microphone which converts the audio signal into a digital format (such as USB, available from HelloDirect (hellodirect.com on the World Wide Web) ) can be connected to the PC enabling audio capture. Audio capture software can capture the audio into memory, hard-drive, removable storage, or transmitted directly to a server through the use of TCP-IP protocols or direct connection through standard data cables such as USB or IEEE 1394 cabling. After capture, the audio can either be stored in a variety of standard audio formats (e.g., MP-3, MP-2, AIFF, WAVE, etc) or directly into a streaming format such as QuickTime, or RealNetworks streaming formats.

A device such as the Mine from Teraoptix Mine can be used to augment digital audio capture and/or Internet connectivity. For example, software written in C, Java or other programming languages which is stored and executed on the Mine device can record the digital audio on the Mine device while communicating with the presentation personal computer. This communication can involve a standardized time generation which is used to generate the time-stamps during the presentation. As a result, this system can segment the audio recording and time-stamping functionality to the Mine device and the image capture occurring on the system being used for the presentation.

i. Addition of search methodologies to on-line presentations

Enhanced search capabilities can be created through the use of speech recognition as well as optical character recognition, abstraction of text and other data and their use in a searchable database (as described above). Meta-data can also be used for indexing and search and retrieval.

ii. Placement of materials on the web and use of emerging distance learning standards

Integration of the media and its presentation on the web is enabled by transmitting the captured audio, visuals and time-stamp information along with other available data (including speech recognition format, closed caption data) obtained as decreased above. The additional search methodologies as well as support of distance learning standards described above can be applied to this embodiment. This data can be placed on a server and made available to end-users over a network (e.g., Intranet, Internet or Wireless Internet network). Alternatively, the presentation can be placed on a removable media such as a CD-ROM or DVD for distribution.

### Conclusion

Methods and systems consistent with the present invention provide a streamlined and automated process for digitally capturing lectures, converting these lectures into Web-ready formats, providing searchable transcripts of the lecture material, and publishing this information on the Internet. The system integrates many different functions into an organized package with the advantages of lowering overall costs of Internet publishing, speeding the publishing process considerably, and providing a fully searchable transcript of the entire lecture. Since the lecture is ready for publishing on the Web, it is viewable on any computer in the world that is connected to the Internet and can use a Web browser. Additionally, anyone with an Internet connection may search the lecture by keyword or content.

The foregoing description of an implementation of the invention has been presented for purposes of illustration and description. It is not exhaustive and does not limit the invention to the precise form disclosed. Modifications and variations are possible in light of the above teachings or may be acquired from practicing of the invention. The scope of the invention is defined by the claims and their equivalents.

What is claimed is:

1. An apparatus for capturing a live presentation, comprising:
means for capturing electronic still for display by a display device which displays said still images for viewing by an audience;
means for recording the audio portion of a speaker's presentation during a live presentation; and
means for automatically synchronizing change over from one still image to another with the audio recording.

2. An apparatus according to claim 1, wherein said means for capturing electronic still images includes means for routing electrical signals intended to drive said display device to said means for synchronizing.

3. An apparatus according to claim 1, wherein said means for capturing electronic still images is housed in an intermediate unit.

4. An apparatus according to claim 1, wherein wherein said means for capturing electronic still images is housed in said display device.

5. An apparatus according to claim 1, further comprising a media server that provides said synchronized still images and audio recording in an Internet format.

6. An apparatus according to claim 1, further comprising an image projection device, said slide originating from one of a computer program.

7. An apparatus according to claim 1, further comprising means for imaging the person giving the live presentation.

8. An apparatus according to claim 1, wherein said means for recording includes a microphone adjacent to the person giving the live presentation.

9. An apparatus according to the claim 1, wherein said means for automatically synchronizing change over one still image to another still image with the audio recording includes a manual input for marking a change over event.

10. An apparatus according to the claim 1, wherein said means for automatically synchronizing change over one still image to another still image with the audio recording includes means for automatically detecting a change over event.

11. An apparatus according to claim 1, further comprising:
means for determining the location of an input device pointer on the display device; and
means for associating a time stamp with a determined location, wherein the automatic synchronizing step further includes the step of storing the determined location of the pointer and the associated time stamp into memory.

12. An apparatus according to claim 1, further comprising:
means for storing the captured still images in a database; and
means for providing search capabilities for searching the database.

13. An apparatus according to claim 12, further comprising means for creating a searchable transcript of text in the still images.

14. An apparatus according to claim 13, wherein said means for creating a transcript includes means for optical character recognition.

15. An apparatus according to claim 14, further comprising means for auto-summarizing the transcript to generate a summary of the transcript.

16. An apparatus according to claim 14, further comprising means for auto-outlining the transcript to generate an outline of the transcript.

17. An apparatus according to claim 1, further including means for transmitting said captured still images and recorded audio portion of a presentation to a network in a format suitable for viewing over the network.

18. An apparatus according to claim 17, further including means for sending the captured still images and audio recording to a client via the Internet.

19. An apparatus according to claim 1, further including means for converting the audio recording of the live presentation into a streaming format for transfer via the Internet.

20. A system for digitally recording and storing a lecture presentation using slides and audio, comprising:
a still image generator for displaying a still image;
a capturing component configured to capture digital still image data from data used to generate the still image, while the still image is being displayed by the still image generator;
a receiving component configured to receive audio signals;
a converting component configured to convert the audio signals into digital audio data; and
a computer including a memory for storing the digital still image data and the digital audio data.

21. The system of claim 20, wherein the system includes a computer connected to the Internet such that the client can access the stored digital still image data and the digital audio data via the Internet.

22. The system of claim 20, wherein the still image generator displays the still image using an overhead transparency projector.

23. The system of claim 20, wherein the still image generator displays the still image using a paper document projector.

24. A computer-readable medium containing instructions for controlling a data processing system to perform a method in a display system with a display device and a memory, the method comprising the steps of:
initiating display of an image;
automatically capturing image data from the image in response to the initiation;
storing the image data in the memory of the display system; and
receiving the image and audio signals associated with the video image, and
wherein the capturing step includes the steps of capturing audio data from the received audio signals; and storing the captured audio data in the memory of the display system.

25. The computer-readable medium of claim 24, wherein the method further includes the step of:
associating a time stamp with the video image data and the audio data to synchronize the video image data with the audio data.
